(19) United States
(12) Patent Application Publication
(10) Pub. No.: US 2005/0064267 A1
(43) Pub. Date: Mar. 24, 2005

(54) Fuel cell system

(76) Inventors: Armin Guttermann, Ulm (DE); Armin Gutermann, Leipheim (DE); Albrecht Sailer, Neu-Ulm (DE); Harald Rebien, Neu-Ulm (DE); Kurt Hohe, Langenau (DE); Thomas Zeiner, Pfaffenhofen-Kacheltshofen (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/496,725

(22) PCT Filed: Nov. 25, 2002
(86) PCT No.: PCT/EP02/13251

(30) Foreign Application Priority Data
Nov. 23, 2001 (DE) 101 58 772.4

(51) Int. Cl. H01M 2/08; H01M 8/04; H01M 4/94

(52) U.S. Cl. 429/37; 429/26; 429/44; 429/36

(57) ABSTRACT

The present application relates to a fuel cell system comprising a fuel cell stack (1) which has layers of a plurality of fuel cells (2) which are each separated from one another by bipolar plates (3; 3′). The bipolar plates have openings for cooling (4) or for the supply (5a) and discharge (5b) of media to/from the fuel cells. The fuel cell stack can be placed under mechanical compressive stress in the direction (6) of the layering. Resilient bead arrangements (7; 7′) are provided at least in regions to seal the openings (4, 5a, 5b, 10).

The present invention relates to a fuel cell system in accordance with the preamble of claim 1.

Fuel cell systems are known in which a stack of fuel cells is constructed with layers of a plurality of fuel cells which are each separated from one another by bipolar plates. The bipolar plates here have a plurality of functions:
electrical contacting of the electrodes of the fuel cells and passing the current on to the adjacent cell (serial connection of the cells),
supplying the cells with reaction gases and e.g. to drain the produced reaction water via a corresponding channel structure,
passing on the heat produced during the reaction in the fuel cell, and
sealing of the various gas or cooling channels from one another and towards the outside.

For supplying media to and draining media from the bipolar plates to the actual fuel cells (these are for example MEAs (Membrane Electron Assembly), each having a gas-diffusion layer formed for example from a carbon mat and orientated towards the bipolar plates), the bipolar plates have openings for cooling or for supplying and draining media.

In particular with respect to the gas-diffusion layer, difficulties regularly arise here. Up to now it has been usual to design the sealing between the bipolar plates or respectively between the bipolar plates and the fuel cell in that for example an elastomer seal is inserted into a groove of the bipolar plate. By exertion of compressive stress (for example by means of tightening straps) on the fuel cell stack, compression of the seal occurs by which means a sealing effect for the openings is intended to be achieved.

Now a problem with the inserted gas-diffusion layer is that it is generally designed as a graphite fibre mat or graphite paper. Standard industrial graphite fibre mats have a nominal thickness of e.g. 340 μm; however the production tolerance is around ±40 μm. The graphite fibres which form the mat are themselves brittle and not resilient. Moreover it is also not recommended here to balance production tolerances of the graphite fibre mat by compressing the mat since the gas permeability of the gas diffusion layer is severely impaired by this and thus the operation of the fuel cell is restricted. On the other hand it is necessary, however, to exert a minimum pressure through the bipolar plate on the entire gas-diffusion layer so that there is adequate electrical conductivity through the gas-diffusion layer.

It can therefore be summarised that with the previous elastomer seals either an imperfect sealing effect or a non-optimal operation of the fuel cell had to be accepted. Added to this, especially in the case of fuel cells operated with molecular hydrogen, losses of H₂ occur due to the gas diffusing through the elastomer seal.

The object underlying the present invention, therefore, is to achieve reliable sealing of the openings in a fuel cell stack with the lowest possible costs.

This object is accomplished by a fuel cell system according to claim 1.

Because resilient bead arrangements are provided at least in regions to seal the openings, reliable sealing is achieved over a long resilient path (a wide range of elastic compressibility) of the bead arrangement. “Openings” are understood in the present application as a region of practically any type which is to be sealed. This can be for example a port for a reaction gas or a coolant. It can however also be e.g. the electrochemically active region in which e.g. the gas-diffusion layer is arranged or screw holes are provided. The resilient bead arrangement constantly permits the balancing of production tolerances of e.g. gas-diffusion layers within a wide tolerance range and yet the provision nevertheless of an optimal sealing effect.

Advantageous embodiments of the invention are described in the dependent claims.

A very advantageous embodiment of the invention provides for the bead arrangement of thin coating for the micro-sealing having a thickness of between 1 μm and 400 μm. The coating is advantageously formed from an elastomer such as silicon, viton or EPDM; these are applied for example in a screen printing process or by CIPG (cure-in-place gasketing; i.e. elastomer introduced in a fluid state at the location of the seal and cured there). What is achieved by these measures is that, for example, the hydrogen diffusion through the seal is reduced to a very low amount.

A further advantageous embodiment of the invention provides for the bead arrangement to contain a complete bead or a half bead. Here it is also possible to provide both forms within one bead arrangement, since according to the course of the bead arrangement in the plane, other elasticities can prove to be sensible, e.g. in narrow radii a different bead geometry could be more sensible compared to straight courses of the bead arrangement.

A further advantageous embodiment provides for the bead arrangement to be formed from steel. Steel offers the advantage that its machining is possible with conventional tools in a very cost-effective way, moreover e.g. methods for coating steel with thin elastomer layers are well tried. The good elastic properties of steel make it possible to form well the wide range of elastic compressibility offered by the invention. Here it is particularly favourable for the bead arrangement to be attached to the bipolar plate. This gives on the one hand the possibility that the bipolar plate is designed overall as a formed steel part (which is perhaps provided in regions with a coating to resist corrosion). However it is also possible that the bipolar plate is designed as a composite element of two steel plates with a plastics material plate lying between them. In each case the good production possibilities of steel can be exploited; it is possible to provide the bead arrangement within a process step which is taking place anyhow (e.g. the imprinting of a flow field). Thus very low costs arise; there are also no additional error sources due to extra components, such as additionally inserted elastomer seals.

However, it is also possible according to the invention to provide the bead arrangement from other metals, such as steel, nickel, titanium or aluminium for example. The choice of preferred metal here depends also on the desired electrical properties or on the desired degree of corrosion resistance.

Thus it is possible to adapt the compression characteristic of the bead e.g. to a gas-diffusion layer. This does not however have to apply only to gas-diffusion layers; the bead characteristics can in general be well adapted to components which have less elasticity. The beaded seal can be designed flexible and thus can be well used by all fuel cell manufacturers without high re-equipping costs.

A further advantageous embodiment provides for the bead arrangement to have a stopper which limits the compression of the gas-diffusion layer to a minimum thickness. This is an incompressible part of the bead arrangement or respectively a part, the elasticity of which is much lower than that of the actual bead. By this means the degree of deformation in the bead region is limited so that the bead cannot be pressed completely flat.

A further advantageous embodiment provides for the bead arrangement to be disposed on a separate component from the bipolar plate. This is particularly propitious when the bipolar plates consist of a material such as graphite which is unsuitable for bead arrangements. The separate component is then placed on the bipolar plate or integrated by gluing, clicking in, welding, soldering in, or by injection mold-around, so that altogether a sealing connection is provided between the separate component and the bipolar plate.

Finally a further advantageous embodiment provides for the bead arrangement to be realised from an elastomer bead. Such a bead can be applied in a screen printing process. This serves both micro- and macro-sealing. The bead also assumes the function of adapting the compression to a gas-diffusion layer.

Further advantageous embodiments of the present invention are given in the remaining dependent claims.

The present invention is now explained with the aid of several figures. These show:

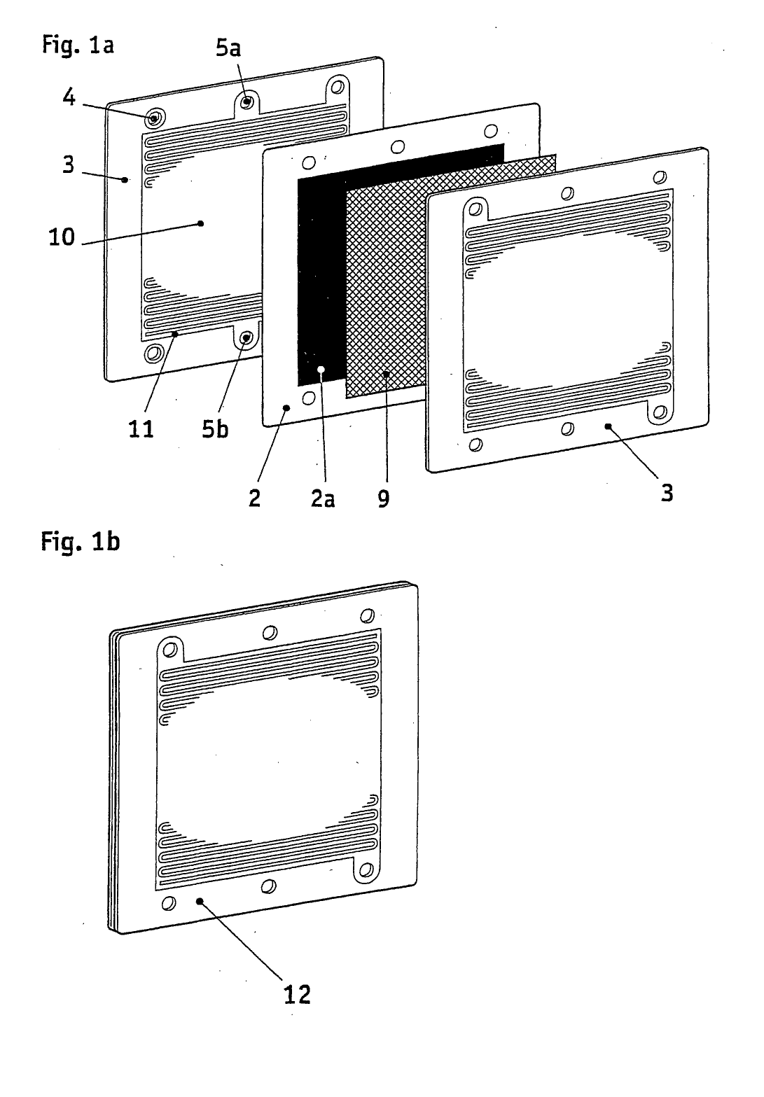

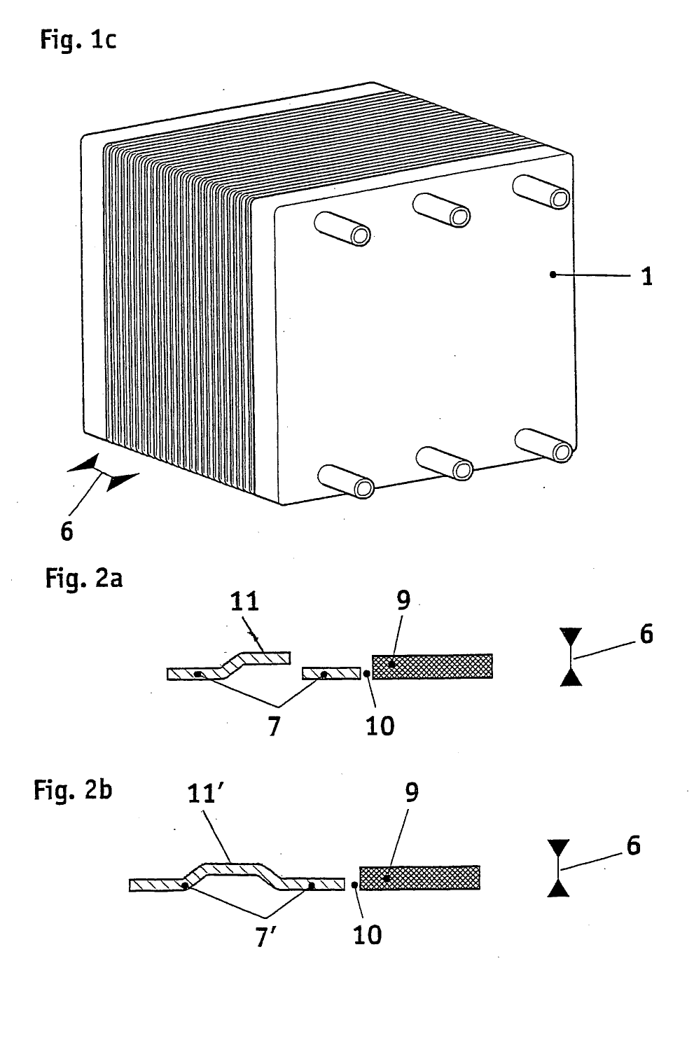

FIGS. 1a to 1c the type of setup of a fuel cell stack,

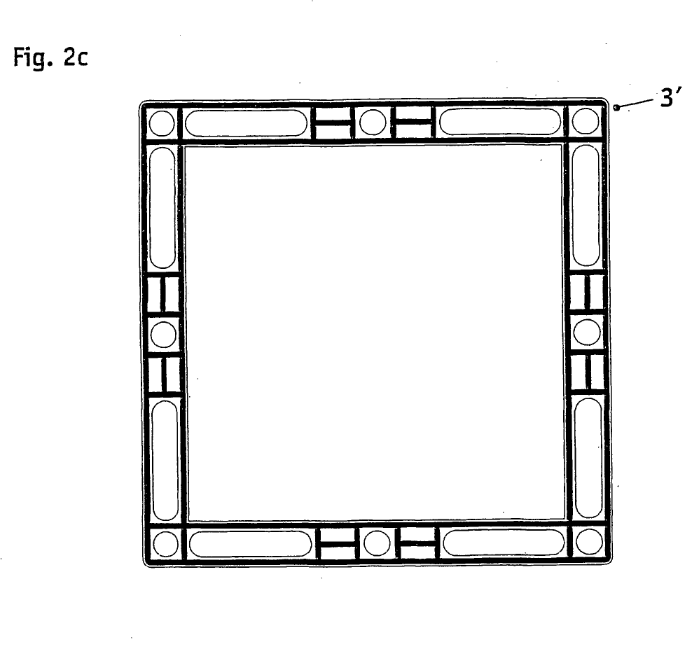

FIGS. 2a + 2b embodiments of bead arrangements according to the invention,

FIG. 2c a plan view of a bipolar plate according to the invention,

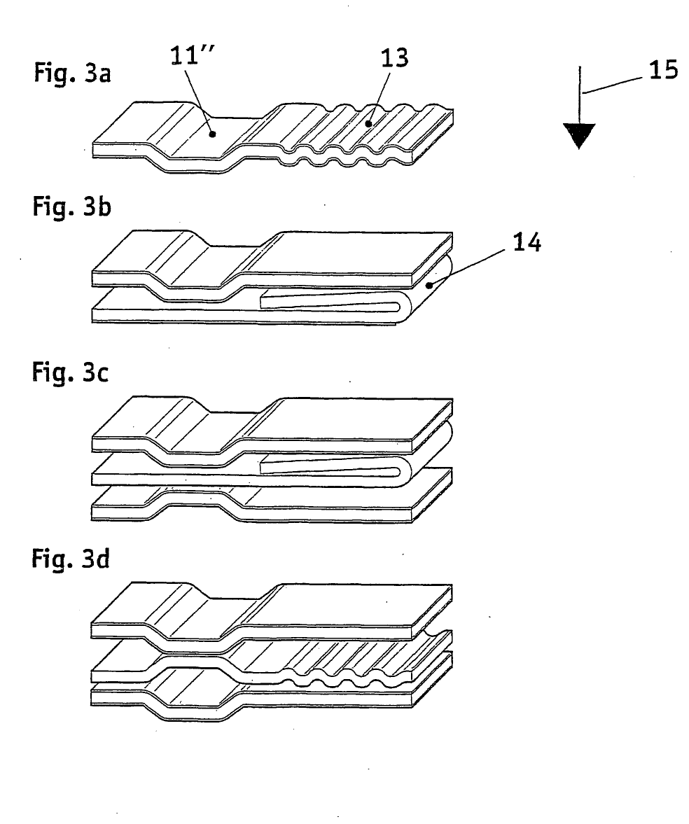

FIGS. 3a to 3d several bead arrangements with stoppers.

FIG. 1a shows the setup of a fuel cell arrangement 12 such as is shown in FIG. 1b. A plurality of fuel cell arrangements 12 forms, in layers, the region of a fuel cell stack 1 disposed between end plates (see FIG. 1c).

In FIG. 1a can be seen a fuel cell 2 with its regular components, which has an ion-conductive polymer membrane which is provided on both sides in the central region 2a with a catalyst layer. In the fuel cell arrangement 12 are provided two bipolar plates 3 between which the fuel cell 2 is disposed. In the region between each bipolar plate and the fuel cell is moreover arranged a gas-diffusion layer 9 which is of such dimensions that it can be accommodated in a recess in the bipolar plate. In the assembled state of the fuel cell 12, the electrochemically active region of the fuel cells, which is substantially covered by the gas-diffusion layer, is arranged in a substantially closed space 10 (this corresponds substantially to the above-mentioned recess in the bipolar plate), which is substantially circumferential limited by a bead 11. This closed space 10 is gas-tight due to the bead 11 which is part of a bead arrangement 7 or 7′ (see FIGS. 2a and 2b).

Ports for the drain of media 5a and for the discharge of media 5b lie within the sealing region and are sealed by the bead 11 from additional ports, for instance the ports for cooling 4 (which have their own bead for sealing). The sealing effect here takes place on all the beads by exertion of compression force on the fuel cell stack 1 in the direction 6 of the layering (see FIG. 1c). This takes place e.g. by means of tightening bands which are not shown here. The bead 11 offers the advantage that it has a wide range of elastic compressibility in which it shows an adequate sealing effect. This is particularly advantageous with the incorporation of the gas-diffusion layer 9, formed from a graphite fibre mat, which is produced in the industry with high production tolerances. Due to the wide range of elastic compressibility of the bead 11, adaptation of the bead to the geometry of the gas-diffusion layer is possible. What is thereby achieved is that on the one hand lateral sealing is achieved and on the other hand both an adequate gas distribution in the gas-diffusion layer plane is given and moreover the pressure distribution in the direction of layering 6 is uniform and sufficiently high to achieve uniform electric conductivity through the gas-diffusion layer. To improve the micro-sealing, the bead 11 is provided on its outer side with a coating of an elastomer which has been applied in a screen printing process.

In order to limit the compression of the gas-diffusion layer, the bead construction is designed with a stopper. This stopper, which can be designed as a crimped portion, a a wave stopper or also as a trapezoid stopper, will be described in more detail below in the description of FIGS. 3a to 3d. All the stoppers have the function that they can limit the compression of the bead to a minimum height.

The bipolar plate 3 is here designed as a metal part. In respect of the ease of manufacture and the advantages of steel in connection with bead arrangements, reference is made to what has already been said.

If the bipolar plate is formed e.g. from a metal which is not suitable for the production of appropriate bead geometries having the necessary elasticity, the bead region can be formed from some other suitable material (e.g. steel). By joining processes such as welding, soldering, gluing, riveting, clicking in, connection of the separate bead component to the bipolar plate then takes place. If the bipolar plates are made of a material other than metal, for example from graphite, graphite composite or plastics material, the bead region can be designed as a frame formed from a suitable material. By joining methods such as melting, injection mold-around, welding, soldering, gluing, riveting, clicking in, the base material of the bipolar plate, which contains the flow field, is connected to a bead sealing frame, which contains the beads, in a gas- or fluid-tight manner.

FIGS. 2a and 2b show two embodiments of a bead arrangement according to the invention. In FIG. 2a is shown a cross-section through the bead arrangement 7 which shows the bead 11, configured as a half bead. The substantially circumferential bead 11 encloses, as already explained in the remarks relating to FIG. 1a, the gas-diffusion layer 9. In FIG. 2a, the bead 11 is designed as a so-called half bead, i.e. for example in the shape of quarter of a circle. Since the inner region of the fuel cell has to be enclosed by a seal, and there are intersections in the region of the media channels (see FIG. 2c), an alternating configuration as a complete bead and as a half bead is necessary. A full bead can here merge into two half beads, which then each have their own sealing effect.

In addition, the use of a full bead or respectively a half bead offers the possibility of adapting the elasticity within wide limits.

FIG. 2a shows the bead arrangement 7 in the uncompressed state. When mechanical compressive stress is exerted on the fuel cell stack, compression takes place in direction 6, such that the bead arrangement 7 or respectively the bead 11 forms a gas-tight lateral seal for the closed space 10 in respect of the gas-diffusion layer.

FIG. 2b shows a further bead arrangement, the bead arrangement 7′. The only difference between this arrangement and that of FIG. 2a consists in the fact that here a bead 11′ is formed as a full bead (here almost with a semi-circular cross-section). There are numerous other embodiments of the present invention. Thus it is for example possible to show other bead geometries than those shown here; multiple beads are also possible. Moreover the bead seal according to the invention is possible for all the seals in the region of the fuel cell stack to be compressed. Thus it is not only possible to seal the electrochemically active region around the gas-diffusion layer, but also any passages for gaseous or fluid media etc. In sealing around the fuel cells stack assembly guide (screw holes), the elasticity of a bead arrangement can be used to counteract displacement in the stack and compensate for possible tolerances.

FIG. 2c shows a plan view of an additional embodiment 3′ of a bipolar plate according to the invention. Here the bead arrangements can be recognised in the plan view by a broad line. The bead arrangements here serve to seal a plurality of ports.

FIGS. 3a to 3d show various bead arrangements which each have a stopper. This stopper serves to limit the deformation of a bead in such a way that it cannot be compressed below a certain specific height.

Thus FIG. 3a shows a single-layer bead arrangement which has a full bead 11″, the deformation of which is limited in direction 15 by a corrugated stopper 13. FIG. 3b shows a two-layer bead arrangement in which a full bead of the upper layer is limited in deformation by a folded metal sheet lying underneath it. FIGS. 3c and 3d show bead arrangements in which at least two complete beads face one another and either a crimped metal sheet (see FIG. 3c) or a corrugated metal sheet (see FIG. 3d) is provided to limit deformation.

1-14. (cancelled)

15. A fuel cell system comprising:
a plurality of fuel cells having an electrochemically active region;
a plurality of bipolar plates separating said fuel cells, said bipolar plates having at least one opening and at least one resilient bead;
wherein said at least one opening transports coolant/media through the fuel cell system, and said at least one resilient bead sealingly encloses said at least one opening over a wide range of elastic compressibility; and
wherein said fuel cell system is under compressive stress in the direction of the fuel cells.

16. The fuel cell system according to claim 15, wherein said at least one resilient bead is integrated into said bipolar plate.

17. The fuel cell system according to claim 15, wherein said at least one resilient bead additionally sealingly encloses said electrochemically active region of said fuel cell.

18. The fuel cell system according to claim 15 additionally comprising a gas diffusion layer disposed between said fuel cell and said bipolar plate.

19. The fuel cell system according to claim 18, wherein said gas diffusion layer is constructed of a material selected from the group consisting of conductive fabric, graphite mat, and graphite paper.

20. The fuel cell system according to claim 15, wherein said at least one resilient bead additionally comprises a coating for improved sealing.

21. The fuel cell system according to claim 20, wherein said coating is an elastomer.

22. The fuel cell system according to claim 20, wherein said coating is deposited by a method selected from the group consisting of screen printing, tampon printing, and cure-in-place gasketing.

23. The fuel cell system according to claim 15, wherein said at least one resilient bead is a full bead.

24. The fuel cell system according to claim 15, wherein said at least one resilient bead is a half bead.

25. The fuel cell system according to claim 15, wherein said at least one resilient bead is constructed of a material selected from the group consisting of steel, nickel, titanium, and aluminum.

26. The fuel cell system according to claim 15, wherein said bipolar plate is a formed metal part.

27. The fuel cell system according to claim 18, wherein said at least one resilient bead additionally comprises a stopper, said stopper limiting compression of said gas diffusion layer.

28. The fuel cell system according to claim 17, wherein said at least one bipolar plate additionally comprises:
a first plate;
a second plate; and
a separator disposed between said first plate and said second plate.

29. The fuel cell system according to claim 28, wherein said first plate and said second plate are metal.

30. The fuel cell system according to claim 28, wherein said separator is plastic.

31. A fuel cell system comprising:
a plurality of fuel cells having an electrochemically active region;
a plurality of bipolar plates separating said fuel cells, said bipolar plates having at least one opening transporting coolant/media through the fuel cell system;
a bead carrier having a at least one resilient bead, said bead carrier disposed between said fuel cell and said bipolar plate; wherein said at least one resilient bead sealingly encloses said at least one opening over a wide range of elastic compressibility; and
wherein said fuel cell system is under compressive stress in the direction of the fuel cell layering.

32. The fuel cell system according to claim 31, wherein said bipolar plate is constructed of a material selected from the group consisting of graphite, plastic, and metal.

33. The fuel cell system according to claim 31, wherein said bead carrier is fixingly attached to said bipolar plate by a method selected from the group consisting of gluing, snap-in, welding, soldering and injection mold-around.
